(19) United States
(12) Patent Application Publication
(10) Pub. No.: US 2007/0097032 A1
(43) Pub. Date: May 3, 2007

(54) Apparatus and method for driving plasma display

(76) Inventors: Beong Ha Lim, Gumi-si (KR); Hak Kyoo Yoo, Seoul (KR); Jeong Pil Choi, Suwon-si (KR)

Correspondence Address: KED & ASSOCIATES, LLP, P.O. Box 221200, Chantilly, VA, 20153-1200, US

(21) Appl. No.: 11/366,826

(22) Filed: Mar. 3, 2006

(30) Foreign Application Priority Data
Oct. 31, 2005 (KR) 10-2005-103126

(51) Int. Cl. G09G 3/28

(52) U.S. Cl. 345/68

(57) ABSTRACT

An apparatus and method for driving a plasma display including first and second electrode driving units for applying a driving waveform to first and second electrodes formed in parallel on a front panel are disclosed. The second electrode driving unit applies a first bias voltage having a certain size not greater than a sustain voltage to the second electrode during a set-up period. That is, the second electrode driving unit does not apply a voltage of a ground level but apply a voltage having a certain size not greater than the sustain voltage, particularly, a voltage of a size of about a half of the sustain voltage, to reduce a potential difference between a scan electrode and a sustain electrode to thereby prevent occurrence of an erroneous discharge. Especially, since the voltage of about the half of the sustain voltage can be implemented by using an output of an energy recovery unit, an additional device is not required, so its cost can be reduced, and in case of using the output of the energy recovery unit, since a free resonance waveform is generated, a possibility of preventing the erroneous discharge can be increased.

### BACKGROUND OF THE INVENTION

1. Field of the Invention

The present invention relates to an apparatus and method for driving a plasma display and, more particularly, to an apparatus and method for driving a plasma display capable of preventing an erroneous discharge by applying a voltage that is about ½ of a sustain voltage to a sustain electrode during a set-up period, and precisely and uniformly controlling wall charges during the set-up period.

2. Description of the Related Art

Generally, a plasma display apparatus is constructed such that barrier ribs formed between upper and lower glass substrates constitute a unit cell, and when an inert gas such as helium-xenon (He—Xe), helium-neon (He—Ne), or the like, in each cell is discharged by a high frequency voltage, vacuum ultraviolet rays are generated to illuminate phosphor formed between the barrier ribs, to thereby allow displaying of images.

Having a simple structure, the plasma display apparatus can be easily manufactured, and its thin outer appearance and low power consumption allow it to receive much attention as a next-generation display apparatus.

FIG. 1 is a driving waveform view of an apparatus for driving a plasma display in accordance with a related art, FIG. 2 is a circuit diagram showing the construction of an apparatus for driving a scan electrode of the plasma display in accordance with the related art, and FIG. 3 is an exemplary view showing a problem of the apparatus for driving the plasma display in accordance with the related art.

In the plasma display apparatus, a plurality of first and second electrodes are formed in parallel on a front panel and a plurality of third electrodes are formed in a direction perpendicular to the first and second electrodes on a rear panel. The electrodes are arranged in a matrix form, forming cells, and a discharge occurs in each cell by a driving waveform.

The first electrodes are scan electrodes (Y) and the second electrodes are sustain electrodes (Z). The third electrodes are address electrodes.

In the related art plasma display apparatus, driving waveforms as shown in FIG. 1 are applied to the scan electrodes and the sustain during one sub-field period.

One sub-field is divided into a reset period, an address period and a sustain period, and the reset period is divided into a set-up period and a set-down period.

During the set-up period, a voltage applied to the scan electrode is gradually increased to increase the amount of wall charges, and during the set-down period, the voltage is gradually decreased to reduce the generated wall charges to a certain amount without a discharge.

In order to perform such operation, a set-up waveform applied to the scan electrode becomes a ramp up (rising) waveform during the set-up period and becomes a ramp down (falling) waveform during the set-down period.

The set-up waveform can be ramp-increased by sustaining its slope from an initial ground level, but since a portion that requires a reset discharge occurs at or above a certain high level voltage, it is not necessary to supply a waveform with a steep slope from the beginning. In this sense, in the related art, a circuit is constructed and operated such that the set-up waveform can be ramp-increased by using a sustain voltage (Vs) as a base voltage.

The set-up operation of the apparatus for driving the scan electrode of the plasma display which applies such driving waveforms will now be described with reference to FIG. 2. In FIG. 2, an energy recovery unit and a sustain voltage apply unit 10 are common parts which are also provided in an apparatus for driving a sustain electrode.

In the related art apparatus for driving the plasma display, when a switching element S1 is turned on and the sustain voltage Vs is applied to a source terminal of a switching element Q1 during the set-up period, the switching element Q1 is turned off while a switching element Q2 is turned on, so that the sustain voltage Vs is applied to a node P1, and thereafter, as the switching element Q1 is turned on, the set-up waveforms as shown in FIG. 1 are generated according to a set-up voltage (Vsetup) and variable resistance.

During the set-up period, the sustain electrode (Z) is sustained by a ground voltage, and a ramp up waveform, which rises from the sustain voltage (Vs), is applied to the scan electrode (Y).

Thereafter, during the set-down period, a bias voltage having the same size as the sustain voltage is applied to the sustain electrode (Z).

In this case, as shown in FIG. 3, when the set-up period starts, since the sustain voltage (Vs) is applied to the scan electrode, an erroneous discharge as shown in FIG. 3 may occur due to a voltage difference between the sustain voltage (Vs) and the ground voltage.

In addition, during the ramp up (rising) period, the voltage difference between the scan electrode and the sustain electrode may cause an erroneous discharge, which results in a problem of degradation of the contrast of an image or the picture quality.

In an effort to solve the problem, if the ramp waveform applied to the scan electrode starts to be increased from the ground voltage, not from the sustain voltage, a ramp up (rising) time would be lengthened, while if the slope is increased abruptly (steeply) in order to shorten the ramp rising time, an erroneous discharge would occur due to the rapid voltage difference

### SUMMARY OF THE INVENTION

The present invention is designed to solve such a problem of the related art, and therefore, an object of the present invention is to provide an apparatus and method for driving a plasma display capable of preventing occurrence of an erroneous discharge by reducing a difference between a voltage applied to a scan electrode and a voltage applied to a sustain electrode during a set-up period by using an existing driving circuit without constructing an additional circuit device.

To achieve the above object, there is provided an apparatus for driving a plasma display in accordance with a first aspect of the present invention, including first and second electrode driving units for applying a drive signal to first and second electrodes formed in parallel on a front panel, wherein the second electrode driving unit applies a first bias voltage having a certain size not greater than a sustain voltage to the second electrode during a set-up period.

Herein, the first bias voltage has a size of about a half of the sustain voltage.

The second electrode driving unit includes an energy recovery unit for recovering energy stored in a panel, and applies an output voltage of the energy recovery unit as the first bias voltage.

The first bias voltage is a waveform which is converged into a size of about a half of the sustain voltage as free resonance is generated.

The first bias voltage is applied substantially simultaneously with a drive voltage which is applied to the first electrode when the set-up period starts.

To achieve the above object, there is also provided an apparatus for driving a plasma display in accordance with a second aspect of the present invention, including: first and second electrode driving units for applying a drive signal to first and second electrodes formed in parallel on a front panel, wherein the second electrode driving unit applies a first bias voltage to the second electrode during a set-up period and a second bias voltage during an address period, and a difference between the first and second bias voltages is not substantially greater than a half of a sustain voltage.

To achieve the above object, there is also provided a method for driving a plasma display in which first and second electrodes are formed in parallel on a front panel and an energy recovery unit recovers/re-supplies energy stored in the panel through the first and second electrodes, including: applying a gradually increased voltage to the first electrode during a set-up period; and applying a first bias voltage having a certain size not greater than a sustain voltage to the second electrode during the set-up period.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a driving waveform view of an apparatus for driving a plasma display in accordance with a related art.

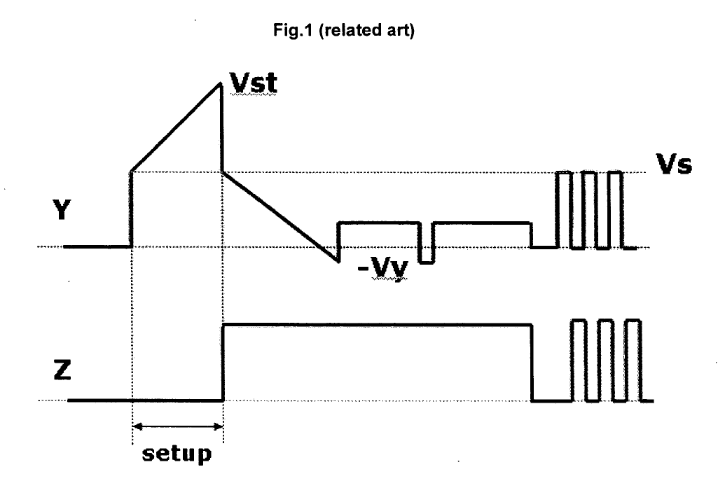

FIG. 2 is a circuit diagram showing the construction of an apparatus for driving a scan electrode of the plasma display in accordance with the related art.

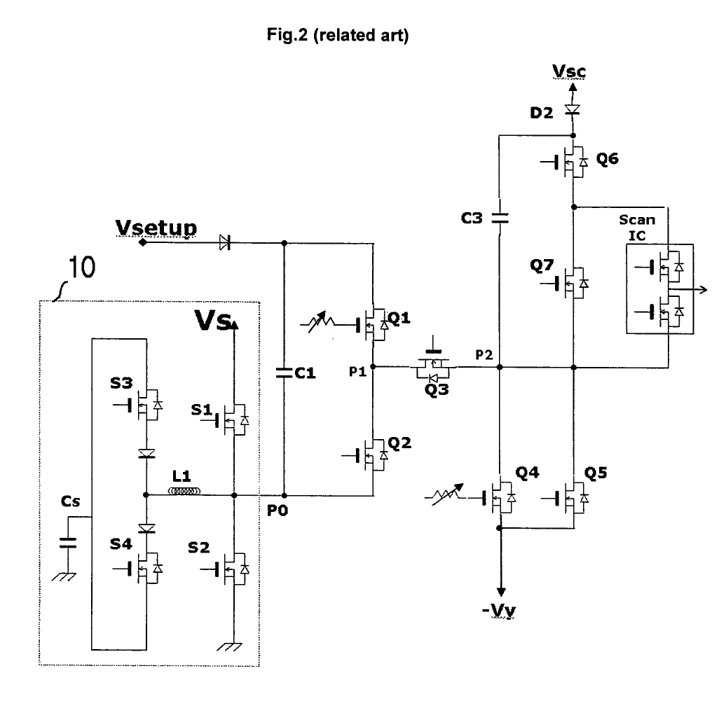

FIG. 3 is an exemplary view showing a problem of the apparatus for driving the plasma display in accordance with the related art.

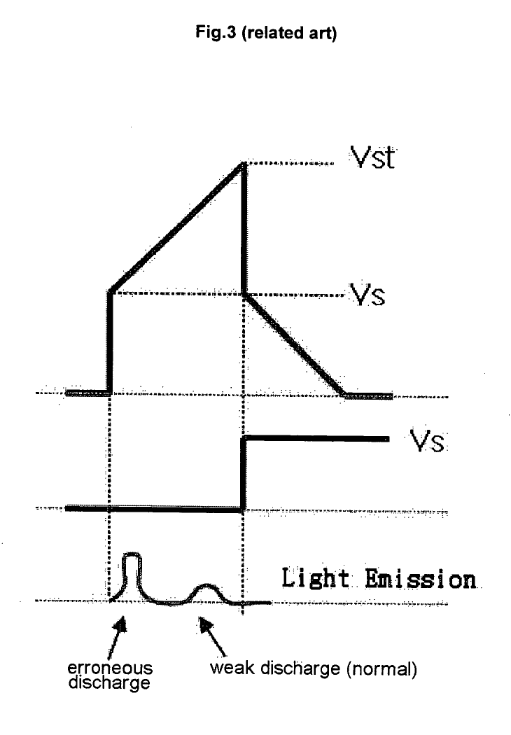

FIG. 4 is a circuit diagram showing an apparatus for driving a plasma display in accordance with the present invention.

FIG. 5 is a view showing driving waveforms and an operation timing of the apparatus for driving the plasma display in accordance with the present invention.

FIG. 6 shows an example of driving waveforms in accordance with the present invention.

FIG. 7 is a view showing time points at which a driving waveform is applied in the apparatus for driving the plasma display in accordance with the present invention.

FIG. 8 illustrates a result of experimentation of driving waveforms of the apparatus for driving the plasma display in accordance with the present invention.

### DETAILED DESCRIPTION OF THE PREFERRED EMBODIMENT

Preferred embodiments of the present invention will be described in detail with reference to the accompanying drawings.

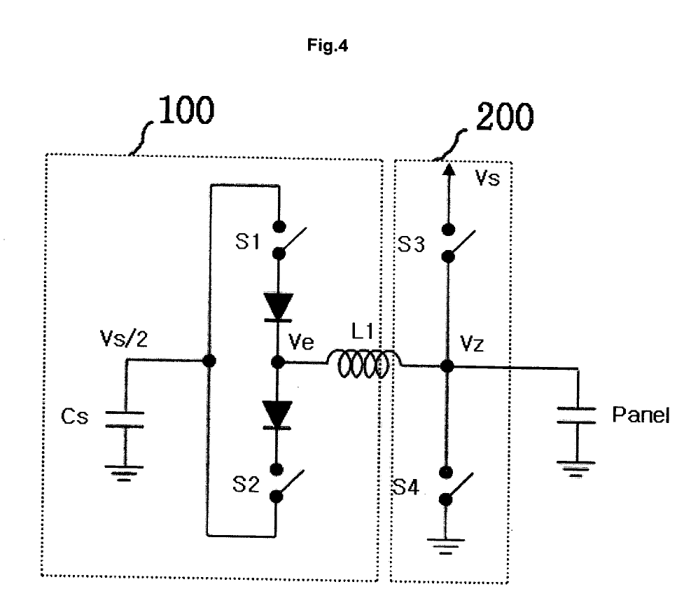

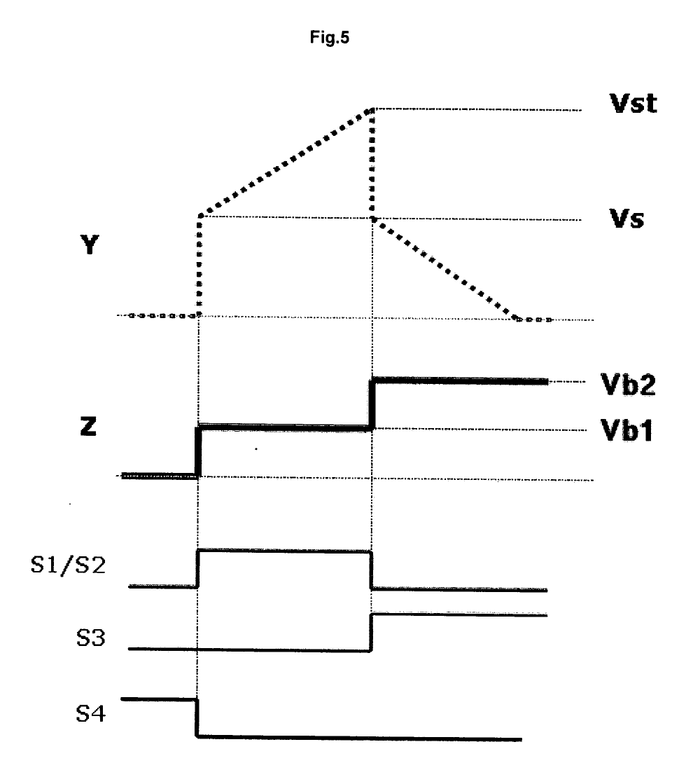

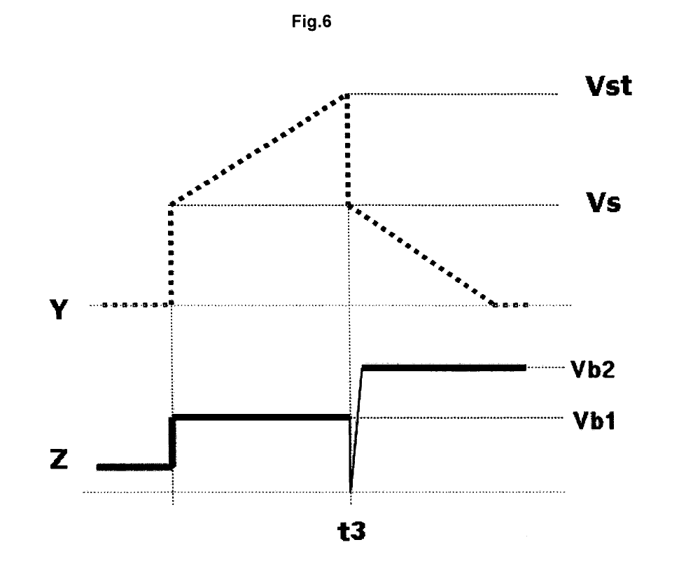

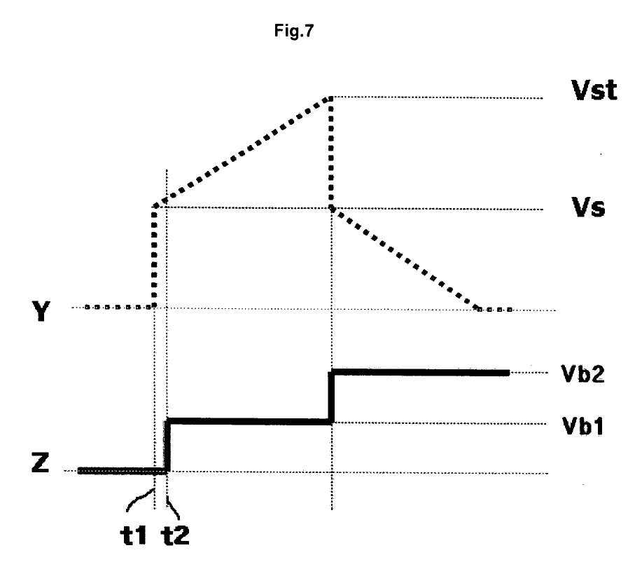

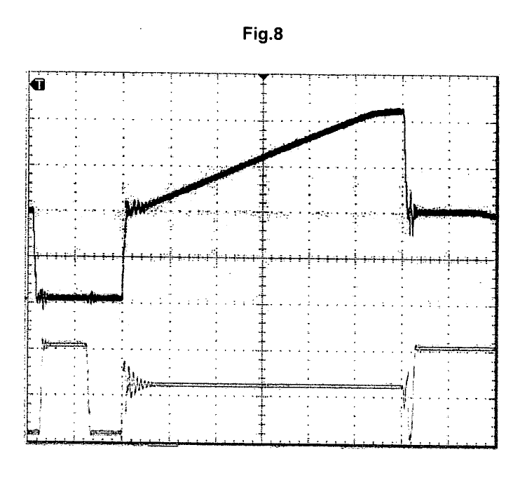

FIG. 4 is a circuit diagram showing an apparatus for driving a plasma display in accordance with the present invention, FIG. 5 is a view showing driving waveforms and an operation timing of the apparatus for driving the plasma display in accordance with the present invention, FIG. 6 shows an example of driving waveforms in accordance with the present invention, FIG. 7 is a view showing time points at which driving waveforms are applied in the apparatus for driving the plasma display in accordance with the present invention, and FIG. 8 illustrates a result of experimentation of driving waveforms of the apparatus for driving the plasma display in accordance with the present invention.

A plasma display apparatus in accordance with the present invention includes first and second electrodes formed in parallel on an upper substrate, first and second electrode driving units for applying a drive signal to the first and second electrodes, and an energy recovery unit for recovering/re-supplying energy stored in a panel.

The first electrode is a scan electrode and the second electrode is a sustain electrode.

The first electrode driving unit applies a driving waveform to the scan electrode of the plasma display panel, and the second electrode driving unit applies a driving waveform which forms or erases wall charges or generates a discharge in unison with the driving waveform applied to the first electrode.

In the apparatus for driving a plasma display in accordance with the present invention, the applied driving waveforms are divided into a reset period, an address period and a sustain period, respectively, per each sub-field, and the reset period is divided into a set-up period and a set-down period.

In the apparatus for driving the plasma display in accordance with the present invention, during the set-up period, a voltage applied to the first electrode is gradually increased to increase the amount of wall charges within a discharge cell, and during the set-down period, the voltage is gradually decreased to reduce the generated wall charges to a certain amount without a discharge. Through such operation, a wall charge distribution that is advantageous for a subsequent discharge is formed within the discharge cell.

The first electrode driving unit applies a waveform which is ramp-increased from a certain base voltage up to a set-up voltage to the scan electrode during the set-up period.

Herein, as the base voltage, a voltage having the same level as the sustain voltage applied during a sustain period or a ground voltage is used. Namely, the first electrode driving unit applies the waveform which rises from the voltage having the same size as the ground voltage or the sustain voltage to the set-up voltage to the first electrode.

The second electrode driving unit applies a first bias voltage (Vb1) having a certain size smaller than the sustain voltage to the second electrode (sustain electrode) during the set-up period.

Thus, by applying the first bias voltage (Vb1) having the certain size, not the ground voltage, during the set-up period, its difference from the voltage applied to the first electrode can be reduced to thereby prevent occurrence of an erroneous discharge.

The plasma display apparatus in accordance with a first embodiment of the present invention is characterized in that the first bias voltage (Vb1) has the size of about a half of the sustain voltage (Vs).

In this case, the voltage of about the half (Vs/2) of the sustain voltage can be applied by using an output of the energy recovery unit.

FIG. 4 is a circuit diagram of the second electrode driving unit. As shown in FIG. 4, the second electrode driving unit includes an energy recovery unit 100 and a sustain voltage applying unit 200.

The energy recovery unit 100 includes a source capacitor (Cs) whose one end is connected with a ground, an inductor (L1) connected with a contact node (Vz) of the sustain voltage applying unit 200, first and second switching elements (S1,S2) connected in parallel between the inductor (L1) and the source capacitor (Cs), and a plurality of diodes connected in series with the switching elements.

The sustain voltage applying unit 200 includes a sustain voltage source (Vs) and third and fourth switching elements (S3 and S4) connected with the voltage source, and one end of the inductor (L1) of the energy recovery unit 100 is connected with a contact node (Vz) of the third and fourth switching elements (S3 and S4).

A panel capacitor is connected with the contact node (Vz), so that resonance occurs between the panel capacitor and the inductor (L1).

About the half voltage (Vs/2) of the sustain voltage is stored in the source capacitor (Cs) of the energy recovery unit 100, and by controlling the plurality of switching elements provided in the second electrode driving unit, the voltage stored in the source capacitor (Cs) can be applied as the first bias voltage (Vb1) during the set-up period.

The operation of controlling the switching elements will be described as follows with reference to FIG. 5.

With the half voltage (Vs/2) of the sustain voltage, which has been recovered from the panel capacitor, stored in the source capacitor (Cs) of the energy recovery unit 100, when the set-up period starts, the switching elements (S1 and S2) of the energy recovery unit 100 are turned on.

Herein, the third switching element (S3) is sustained in an OFF state and so does the fourth switching element (S4).

According to the switching operation, immediately when the set-up period starts, the half voltage (Vs/2) of the sustain voltage stored in the source capacitor is applied to the first bias voltage (Vb1).

At this time, a waveform which rises at a certain slope up to a set-up voltage (Vst) by using the sustain voltage (Vs) or the ground voltage as a base voltage is applied to the first electrode.

Accordingly, since a potential difference between the first and second electrodes becomes the half voltage (Vs/2) of the sustain voltage at the initial stage of the set-up period, which is a reduced value smaller than that of the related art, a possibility of an erroneous discharge can be reduced.

In addition, when the set-up period starts, free resonance is generated with the panel capacitor according to the switching operation in the energy recovery unit 100.

In this case, over the free resonance, a maximum potential becomes higher than the half voltage (Vs/2) of the sustain voltage, further reducing the potential difference between the first and second electrodes, so occurrence of the erroneous discharge can be more effectively prevented.

Thus, since the resonance is generated at the initial stage of the set-up period, the driving waveform applied to the second electrode is gradually converged into the half voltage (Vs/2) of the sustain voltage.

When the set-up interval, during which the half voltage (Vs/2) of the sustain voltage is applied, ends, the sustain voltage (Vs) is applied by the sustain voltage applying unit 200 during the set-down period and the address period likewise as in the related art.

In this case, a voltage lower than the sustain voltage can be applied as the first bias voltage (Vb1) during the set-up period and the address period.

In this case, as shown in FIG. 6, since the free resonance is generated between the source capacitor of the energy recovery unit 100 and the panel capacitor at a time point (t3) when the set-up period ends, resonance waves are instantly generated to drop the voltage to the ground voltage, and then, the second bias voltage (Vb2) having the substantially same size as the sustain voltage is sustained during the set-down period.

A plasma display apparatus in accordance with another embodiment of the present invention includes first and second electrode driving units for applying driving waveforms to first and second electrodes formed in parallel on a front panel, in which the first electrode driving unit applies a first bias voltage (Vb1) to the second electrode during the set-up period and applies a second bias voltage (Vb2) during the address period, and in this case, a difference between the first and second bias voltages is not substantially greater than a half of the sustain voltage.

Namely, when the output of the energy recovery unit 100 is not used as a source of the first bias voltage (Vb1), the first bias voltage is applied by using an additional power source.

Thus, in the case where the output of the energy recovery unit is not applied as the first bias voltage (Vb1) but an additional power source is used or in the case where the first bias voltage is not the half (Vs/2) of the sustain voltage, the difference between the first and second bias voltages (Vb1 and Vb2) needs to be controlled to be substantially smaller than the half of the sustain voltage.

When the first bias voltages (Vb1) has a voltage difference value from the second bias voltage (Vb2) by about the half (Vs/2) of the sustain voltage or smaller, a potential difference between a ramp waveform applied to the first electrode and the first bias voltage can be reduced as in the first embodiment of the present invention, so occurrence of an erroneous discharge can be prevented.

If the difference between the first and second bias voltages (Vb1 and Vb2) exceeds about the half (Vs/2) of the sustain voltage, the potential difference between the voltage applied at the initial stage of the set-up period and the first bias voltage (Vb1) applied to the second electrode would be increased to generate the erroneous discharge.

FIG. 7 is a view showing time points at which a driving waveform is applied in the apparatus for driving the plasma display in accordance with the present invention.

In the plasma display apparatus in accordance with the present invention, after a time point (t1) at which the ramp waveform is applied to the first electrode, the first bias voltage (Vb1) is applied to the second electrode at a time point (t2), or as shown in FIG. 5, the first bias voltage (Vb1) is simultaneously applied to the second electrode in synchronization with the time point when the ramp waveform is applied to the first electrode.

In this case, it is preferred that the first bias voltage (Vb1) is simultaneously applied to the second electrode in synchronization with the time point when the ramp waveform is applied to the first electrode (t1=t2). The reason for this is because the resonance waveform is generated according to the switching in the energy recovery unit 100, and in this case, the closer a first maximum potential value of the resonance waveform is to a time point when the ramp waveform is applied, the better an erroneous discharge preventing effect can be obtained.

FIG. 8 shows a result of a waveform obtained from experimentation as outputted to an oscilloscope in accordance with the present invention.

A method for driving a plasma display in accordance with the present invention includes a first step of applying a gradually increased voltage to the scan electrode during the set-up period of a driving waveform applied to the plasma display panel, and a second step of applying the first bias voltage (Vb1) having the size not greater than the sustain voltage to the sustain electrode during the set-up period.

In the first step, a voltage having the substantially same size as the sustain voltage or a voltage which is gradually increased up to the set-up voltage from the ground voltage is applied.

In this embodiment, the first bias voltage (Vb1) in the second step has the size of about the half of the sustain voltage.

In this case, if a different voltage value is used as the first bias voltage (Vb1), an additional voltage source must be provided, but in case of using the half voltage (Vs/2) of the sustain voltage, the output value of the energy recovery unit 100 can be used, so it is not necessary to construct an additional device.

The output value of the energy recovery unit 100 is a voltage value stored in the source capacitor of the energy recover unit 100.

Accordingly, it is characterized in that the first bias voltage (Vb1) is the output voltage of the energy recovery unit 100. The recovery voltage value stored in the source capacitor of the energy recover unit 100 is the half (Vs/2) of the sustain voltage. By turning on the switching element of the energy recovery unit 100 and simultaneously turning off the switching element connected with the sustain voltage source (Vs), a corresponding output value can be used as the first bias voltage (Vb1).

Resonance is generated between the inductor (L1 in FIG. 4) of the energy recovery unit 100 and the panel capacitor according to the switching operation, and at the time point when the switching operation is performed, the resonance waveform is generated.

Accordingly, in the method for driving the plasma display, in order to use the resonance waveform, a set-up waveform is applied to the scan electrode and, at the same time, the first bias voltage (Vb1) is applied to the sustain electrode.

Then, at the time point when the first bias voltage (Vb1) starts to be applied, resonance is generated, and thus, the first bias voltage (Vb1) is gradually converged into the size of about the half of the sustain voltage.

In this case, the potential difference between the first and second electrodes can be reduced by using the free resonance waveform which is generated at the initial stage of the set-up period, to thereby reduce an erroneous discharge.

In addition, when the set-up period ends (t3), resonance is generated according to the operation of the switching element, so the first bias voltage can be reduced to the ground voltage and the second bias voltage can be applied during the following set-down period.

The second bias voltage has the substantially same size as the sustain voltage.

The foregoing description of the preferred embodiments of the present invention has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto and their equivalents.

What is claimed is:

1. A plasma display apparatus comprising:
first and second electrode driving units for applying a drive signal to first and second electrodes formed in parallel on a front panel,
wherein the second electrode driving unit applies a first bias voltage having a certain size not greater than a sustain voltage to the second electrode during a set-up period.

2. The apparatus of claim 1, wherein the first bias voltage has a size of about a half of the sustain voltage.

3. The apparatus of claim 1, wherein the second electrode driving unit comprises an energy recovery unit for recovering energy stored in a panel, and applies an output voltage of the energy recovery unit as the first bias voltage.

4. The apparatus of claim 3, wherein the energy recovery unit comprises:
a source capacitor for recovering and storing panel energy;
an inductor connected with the panel capacitor; and
first and second switching elements connected in parallel between the inductor and the source capacitor

5. The apparatus of claim 4, wherein first and second switching elements are turned on during the set-up period.

6. The apparatus of claim 5, wherein the first bias voltage is a waveform which is converged into a size of about a half of the sustain voltage as free resonance is generated.

7. The apparatus of claim 1, wherein the first bias voltage is applied substantially simultaneously with a drive voltage which is applied to the first electrode when the set-up period starts.

8. The apparatus of claim 1, wherein the second electrode driving unit reduces the first bias voltage to a ground voltage and then applies the second bias voltage greater than the first bias voltage during a set-down period.

9. The apparatus of claim 8, wherein the second bias voltage has the substantially same size as the sustain voltage.

10. The apparatus of claim 1, wherein the first electrode driving unit applies a waveform which rises up to a set-up voltage from a certain base voltage during the set-up period.

11. A method for driving a plasma display apparatus comprising first and second electrodes formed in parallel on a front panel and an energy recovery unit for recovering and re-supplying energy stored in the panel through the first and second electrodes, comprising:
a first step of applying a gradually increased voltage to the first electrode during a set-up period; and
a second step of applying a first bias voltage having a certain size not greater than a sustain voltage to the second electrode during the set-up period.

12. The method of claim 11, wherein, in the second step, the first bias voltage having a size of about a half of the sustain voltage is applied.

13. The method of claim 11, wherein, in the second step, an output voltage of the energy recovery unit is applied as the first bias voltage.

14. The method of claim 11, wherein, in the first step, the voltage which is gradually increased from the substantially same size as that of the sustain voltage is applied.

15. The method of claim 14, wherein, in the first step, the voltage which is gradually increased up to a set-up voltage is applied.

16. The method of claim 11, wherein, in the second step, the first bias voltage, which is freely resonated so as to be gradually converged into the size of about a half of the sustain voltage, is applied.

17. The method of claim 11, wherein, in the second step, the first bias voltage is applied substantially simultaneously with a drive voltage which is applied to the first electrode.

18. The method of claim 11, wherein, in the second step, after the first bias voltage is reduced to a ground voltage, a second bias voltage greater than the first bias voltage is applied during a set-down period.

19. The method of claim 18, wherein the second bias voltage has the substantially same size as the sustain voltage.

20. A plasma display apparatus comprising:
first and second electrode driving units for applying a drive signal to first and second electrodes formed in parallel on a front panel,
wherein the second electrode driving unit applies a first bias voltage to the second electrode during a set-up period and a second bias voltage to the second electrode during an address period, and a difference between the first and second bias voltages is not substantially greater than a half of a sustain voltage.
